(19) United States
(12) Patent Application Publication
(10) Pub. No.: US 2022/0133058 A1
(43) Pub. Date: May 5, 2022

(54) Children's Swivel Bed and Seat

(71) Applicant: Manuel Mazissa Gomes, York, PA (US)

(72) Inventor: Manuel Mazissa Gomes, York, PA (US)

(21) Appl. No.: 16/420,147

(22) Filed: May 22, 2019

(51) Int. Cl. A47D 9/00; H02P 23/16; A47D 1/00

(52) U.S. Cl. CPC A47D 9/00; A47D 1/002; H02P 23/16

(57) ABSTRACT

For this invention I took into account two basic aspects: the application of induction motors its speeds and the weight of children newly born until 3 years old.

The present invention will have as components; the induction motor specifically of single phase power, a support structure, a bed or a seat.

For this invention, the dimensions of the induction motor, such as, the stator, the rotor, the shaft and its length, the speeds, will be according to the weight of children's between age 0 to 3 years old. The two speeds that will have will be slower than those of the fans of home and commercial establishments. These are the modifications that will be made in the single phase induction motor.

The new section on invention is the bed or the seat that will be connected to the shaft to allow the bed to rotate.

Another new aspect of the invention is the support structure in which the motor will be placed in a vertical position. The support structure will be circular and with a certain height. Therefore the bed will be also circular, rectangular or another configuration.

The induction motor inside the support structure will be permanent, while the bed can be mounted or disassembled as well as the seat.

### TECHNICAL FIELD

This invention relates to Children's Swivel Bed and Seat. It is an application of the induction motor more specifically a single-phase power that is used for domestic purposes and commercial as well.

### BACKGROUND OF THE INVENTION

An induction motor is a type of electric motor that converts electric power into rotary motion. An induction motor uses the principle of electromagnetic induction to cause the rotor to turn. Electric current is supplied to the stator, which induces a magnetic field that rotates. The rotating magnetic field interacts with the rotor, inducing current in the rotor. The interaction of the two magnetic fields results in a torque, turning the rotor within the motor casing. Because the induction motor does not use brushes like DC motors, there is less wear of the internal parts.

The stator is the stationary portion of the motor and delivers a rotating magnetic field to interact with the rotor. One or more copper windings make up a “pole” within the stator, and there is always an even number of poles within a motor. The electric current alternates through the poles, resulting in a rotating magnetic field.

The rotor is the central component of the motor and is fixed to the shaft. The rotor is generally constructed of copper or aluminum strips attached at each end to a circular fixture. This configuration is called a “squirrel cage rotor” because of its appearance. The magnetic field generated by the stator induces a current in the rotor, which then creates its own magnetic field. The interaction of the magnetic fields in the stator and rotor results in a mechanical torque of the rotor. In some induction motors, the copper bars are replaced with slip rings and copper windings that behave in the same way.

The motor shaft is fixed within the rotor and rotates with it. The shaft extends outside of the motor casing and allows a connection to an outside system to transmit the rotational power. The shaft is sized to the amount of torque the motor puts out to avoid breaking the shaft.

The induction motors are classified in single phase and three phases.

We use the single-phase power system more widely than three phase system for domestic purposes, commercial purposes and some extent in industrial uses. Because, the single-phase system is more economical than a three-phase system and the power requirement in most of the houses, shops, offices are small, which can be easily met by single phase system. The single-phase motors are simple in construction, cheap in cost, reliable and easy to repair and maintain. Due to all these advantages, the single-phase motor finds its application in vacuum cleaners, fans, washing machines, centrifugal pumps, blowers, washing machines, etc.

The present invention will have the same components of induction motor of fans and the same operating principle. The only difference will be on size of stator, rotor, shaft and the length. Also, it will have two speeds.

### BRIEF SUMMARY OF THE INVENTION

Children's Swivel Bed and Seat, it is a product for children's with ages between 0 to 3 years old. The weight of the newborn until 3 years old, it will not affect the operation of the motor. For a newborn baby up to 12 months, the speed will be low and for 2 years old up to 3 years old the speed will be medium. The speed with which the motor will rotates will depend on the weight of the child.

The invention will have the following components: an induction motor, a support structure, and a bed or a seat.

The induction motor will be the type single phase with two speeds; medium and low. As the weight of children varies between the indicated ages above, the speed of induction motor will be also different.

The induction motor will be placed on vertical position inside of support structure. The bed or seat will be coupled with the shaft of motor.

### BRIEF DESCRIPTION OF THE SEVERAL VIEWS OF THE DRAWING

These and other objects, features and advantages of the present invention will become better understood with regard to the following description, pending claims and accompanying drawings where:

FIG. 1 is the front view of the support structure together with the motor inside it and tightened with a screw on the plate.

FIG. 2 is the top view of the support structure containing the motor, shaft and bolts.

FIG. 3 is the front view of the bed and a piece pipe to be coupled with the shaft of motor.

FIG. 4 is the front view of the shaft of motor.

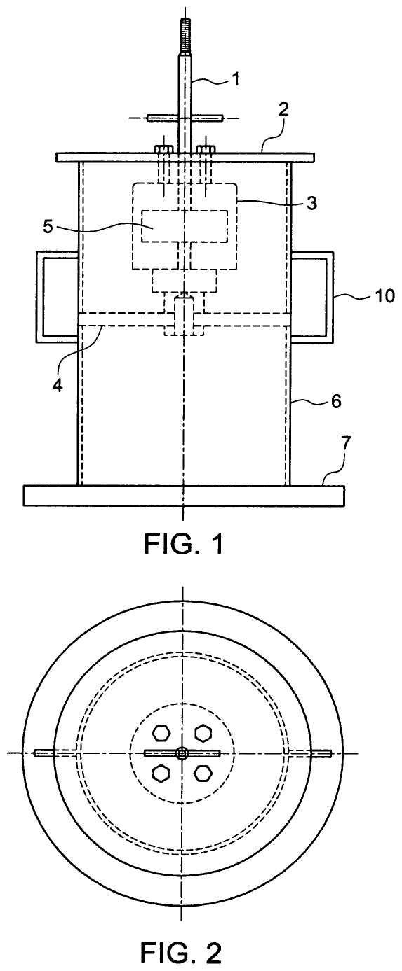

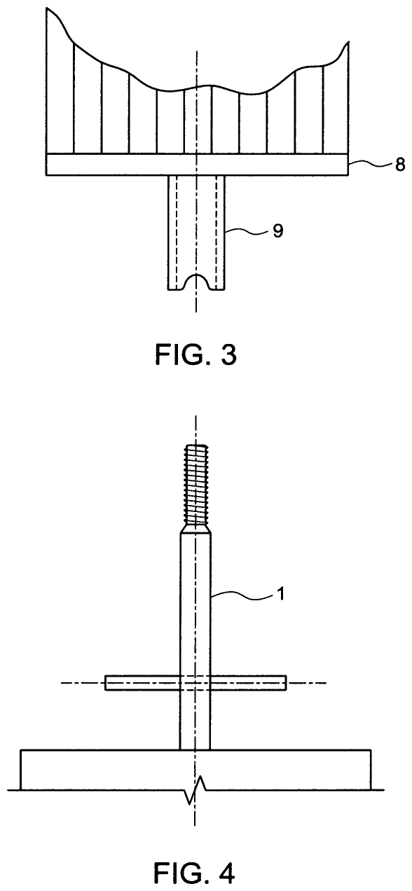

### DETAILED DESCRIPTION OF THE INVENTION

The induction motor has several applications, such as in vacuum cleaners, fans, washing machines, centrifugal pumps, blowers, washing machines, etc.

For this invention I took into account two basic aspects: the application of induction motors its speeds and the weight of children newly born until 3 years old.

The present invention, children's swivel bed and seat, is formed by an induction motor 3, a support structure 6, a bed or a seat 8. It will be only for children with ages between 0 to 3 years old. On both sides of support structure 6, will have the lifting hands 10.

The induction motor 3 will be a single-phase type and will have the following components: a stator 3, a rotor 5 and a shaft 1. All these components, their dimensions will depend on the weight of the children since it varies between the indicated ages. Another new aspect in the invention, is the speed, it will have two speeds; a medium speed and a low as well. The normal weight of the children newly born is xxx and when to turn 12 months, it will not be the same weight. Therefore the weight may also influence on speed of the motor 3, on dimension of the shaft 1. While the length of the shaft 1, will depend on the point of application of the motor 3 within the support structure 6 in a vertical position. The base of the motor 3 will have screws to allow its connection with a metal plate 4 welded inside the support structure 6. The shaft 1 will be coupled with the bed or the seat 8 to allow the movement and the rotation of both.

The fans used at houses, have an induction motor 3 in which the speeds are slower compared with other devices, such as in vacuum cleaners, washing machines, and blowers. For this invention, the two speeds that the motor 3 will have will be slower than the two speeds of the fans used with homes purposes. The material of motor 3 and the shaft 1 will be the same as those that already exist.

The support structure 6 will be like a pipe, will have a height of approximately 38″, a diameter of 24″, and the distance to where the motor 3 will be placed will be 8″. It will have a base plate upper 2 and lower base plate 7 as well with 28″ and 36″ respectively. Both plates will be welded and the upper 2 will have the same number of holes corresponding to the number of screws that the motor will have 3. Also it will have two lifting hand 10.

The bed 8 will have a metal plate with the same dimension of the upper plate 2 of the support structure 6 and will be circular, as it could also be rectangular. The diameter of the bed may change because the child when he completes 12 months will have another height as well as up to 3 years. In the lower part it will have a piece pipe 9 with a diameter almost equal to the shaft 1 of the motor and a smaller height of the shaft 1. The seat in the lower part will have the same configuration of the bed 8.

In the present invention, the bed and the seat 8 will have to be mounted on the support structure 6 and removable when necessary. But in the future it may be that the bed will be welded on the upper plate 2 of the support structure 6.

The invention claimed is:

1. Children's Swivel Bed and Seat, it is a product for children's with ages between 0 to 3 years old. The weight of the newborn until 3 years old, it will not affect the operation of the motor. For a newborn baby up to 12 months, the speed will be low and for 2 years old up to 3 years old the speed will be medium. The speed with which the motor will rotates will depend on the weight of the child.

2. Children's Swivel Bed and Seat of claim 1, wherein the present invention will have as new components; a support structure, a bed or a seat.

3. Children's Swivel Bed and Seat of claim 1, further comprising as new, the dimensions of the induction motor, such as, the stator, the rotor, the shaft and its length, the speeds, will be according to the weight of children between age 0 to 3 years old.

4. Children's Swivel Bed and Seat of claim 3, wherein the two speeds that will have will be slower than those of the fans of home and commercial establishments.

5. Children's Swivel Bed and Seat of claim 1, further comprising as new the motor will be placed in a vertical position.

6. Children's Swivel Bed and Seat of claim 1, wherein the bed or seat will be connected to the shaft to allow the bed to rotate.

7. Children's Swivel Bed and Seat of claim 5, wherein the induction motor inside the support structure will be permanent, while the bed can be mounted or disassembled as well as the seat.

8. Children's Swivel Bed and Seat of claim 1, further comprising the bed 8 will have a metal plate with the same dimension of the upper plate 2 of the support structure 6 and will be circular, as it could also be rectangular or another configuration.

9. Children's Swivel Bed and Seat of claim 7, further comprising the present invention will have the same components of induction motor of fans and the same operating principle. The only difference will be on size of stator, the rotor, the shaft and the length. Also, it will have two speeds.
